(19) United States
(12) Patent Application Publication
(10) Pub. No.: US 2012/0140329 A1
(43) Pub. Date: Jun. 7, 2012

(54) LIGHT GUIDE BODY WITH INTEGRAL STRUCTURE AND METHOD FOR MAKING SAME

(75) Inventor: SEI-PING LOUH, Tu-Cheng (TW)

(73) Assignee: HON HAI PRECISION INDUSTRY CO., LTD., Tu-Cheng (TW)

(21) Appl. No.: 13/028,166

(22) Filed: Feb. 15, 2011

(30) Foreign Application Priority Data
Dec. 7, 2010 (TW) 99142699

(51) Int. Cl. G02B 5/02; B29D 11/00; B05D 5/06

(52) U.S. Cl. 359/599; 427/163.2; 427/516; 264/1.24

(57) ABSTRACT

A light guide body includes a first solidified colloid layer, a second solidified colloid layer and a third solidified colloid layer. The first solidified colloid layer has a number of light-scattering microstructures at an upper portion thereof. The second solidified colloid layer is formed on and coming into contact with the upper portion of the first colloid layer, and the second colloid layer covers the microstructures. The third solidified colloid layer is formed on the second colloid layer, and the third colloid layer has a plurality of light condensing prisms at an opposite side thereof to the second colloid layer. The light guide body has an integral structure with a number of optical functions. A method for making the light guide body is also provided.

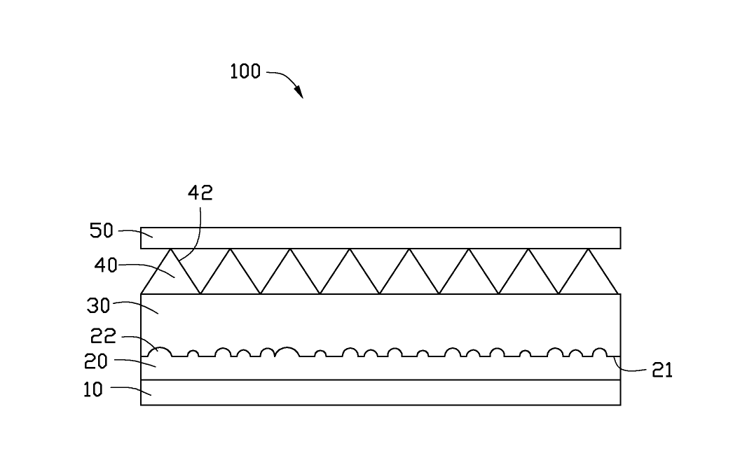

### BACKGROUND

1. Technical Field

The present disclosure relates to a light guide body with an integral structure, and a method for making the same.

2. Description of Related Art

Light guide bodies for guiding light are widely used in back light modules. Usually, one light guide body only has one function, such as scattering light, or condensing light. Such light guide bodies may be plates, sheets, or film. The plurality of light guide bodies assembled together can form a light guide module having the plurality of functions.

However, the assembled light guide module is usually bulk in volume, and light loss happens between the plurality of light guide bodies.

What is needed, therefore, is a light guide body with an integral structure and a method for making the same, which can overcome the above shortcomings.

### BRIEF DESCRIPTION OF THE DRAWING

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

The drawing is a schematic view of a light guide body in accordance with one embodiment.

### DETAILED DESCRIPTION

Embodiments of the present light guide body and method will now be described in detail below and with reference to the drawing.

Referring to the drawing, an exemplary light guide body 100 includes light-transmissible a first colloid layer 20, a second colloid layer 30 and a third colloid layer 40. The first colloid layer 20, the second colloid layer 30 and the third colloid layer 40b are solidified in sequence to be an integral structure.

The first colloid layer 20 and the second colloid layer 30 each are made of one of epoxy, polymethyl methacrylate (PMMA), or silicone. The interface 21 interconnecting the first colloid layer 20 and the second colloid layer 30 has a plurality of microstructures 22 for scattering light. The first and second colloid layers 20, 30 are formed and solidified in sequence to form the interface 21. In the present embodiment, the microstructures 22 are micro-protrusions.

The microstructures 22 can be made using a mold imprint method or particle precipitation method (see the following disclosure). In particular, when the first and second colloid layers 20, 30 are made from a same material, and the microstructures 22 are made using the mold imprint method, the microstructures 22 preferably have deeper depth. Such that, when the second colloid layer 30 is coated on microstructures 22, the concave portions of the microstructures 22 is not filled completely, the interface 21 still has the microstructures 22.

When the first colloid layer 20 and the second colloid layer 30 are made of different material, the interface 21 with the microstructures 22 remains although the second colloid layer 30 is coated thereon.

The third colloid layer 40 is made of a UV curing adhesive. The third colloid layer 40 has a plurality of light condensing prisms 42 integrally formed therein. A cross section of each of the light condensing prisms 42 is in a triangular shape. The light condensing prisms 42 covers an entire surface of the second colloid layer 30. In the present embodiments, the light condensing prisms 42 are in an array, and bottom edges of the light condensing prisms 42 are in contact with the opposite surface of the second colloid layer 30 to the interface 21. In other embodiments, the light condensing prisms 42 can be formed in only an upper portion of the third colloid layer 40, i.e, bottom edges of the light condensing prisms 42 may not be necessarily in contact with the surface of the second colloid layer 30.

The light guide body 100 further includes a bottom protection film 10 and a top protection film 50. The bottom protection film 10 is underlain on the opposite surface of the first colloid layer 20 to the interface 21. The top protection film 50 covers the light condensing prisms 40. The surfaces of each of the bottom protection film 10 and the top protection film 50 are flat, and the bottom protection film 10 and the top protection film 50 have a removable property, and can be removed from the colloid layers without damage to the colloid layers. The bottom protection film 10 and the top protection film 50 each can be made of a different material from the colloid layer adjacent thereto, and can be flexible. The bottom protection film 10 and the top protection film 50 are configured for preventing contamination and damage to the colloid layers. When the light guide body 100 is in application, the bottom protection film 10 and the top protection film 50 can be removed from the colloid layers. The bottom protection film 10 and the top protection film 50 can be repeatedly used in making the light guide body 100 as follows.

First, forming an unsolidified light-transmissible first colloid layer 20 on the bottom protection film 10, that is, the bottom protection film 10 can serve as a base for the forming of the light guide body 100.

Second, forming the microstructures 22 on the first colloid layer 20, and then solidify the first colloid layer 20 with the microstructures 22. Wherein, the microstructures 22 can be made using a mold imprint method to integrally form the microstructures 22 on the first colloid layer 20. In addition, particles can be precipitated in the surface of the first colloid layer 20 to form the microstructures 22. Such particles are light-transmissible and have high refractive index.

Third, an unsolidified light-transmissible second colloid layer 30 is formed on the microstructures 22, and then the second colloid layer 30 is solidified. After the second colloid layer 30 is solidified, the second colloid layer 30 can serve as a support for the forming of the light condensing prisms 42. A thickness of the second colloid layer 30 is a little greater than the first colloid layer 20 to support the light condensing prisms 42 appropriately and would not damage the concave-convex structure 22.

The first and second colloid layers 20, 30 can be solidified using heat solidifying method or electron beam radiation curing method.

Fourth, an unsolidified light-transmissible third colloid layer 40 is formed on the second colloid layer 30. After that, the light condensing prisms 42 are formed in the third colloid layer 40 from an opposite side of the third colloid layer 40 to the second colloid layer 30. In the present embodiment, the light condensing prisms 42 are in an array, a cross section of each of the light condensing prisms 42 is in a triangular shape, and bottom edges of the light condensing prisms 42 are in contact with and over the entire the opposite surface of the second colloid layer 30 to the interface 21. A mold imprint method can also be used in the forming of the light condensing prisms 42. After the light condensing prisms 42 are formed, the entire third colloid layer 40 can be solidified using UV light curing method.

In other embodiments, the light condensing prisms 42 can be formed in only an upper portion of the third colloid layer 40, i.e, bottom edges of the light condensing prisms 42 may not be necessarily in contact with the surface of the second colloid layer 30.

After the third colloid layer 40 is solidified, the top protection layer 50 can be applied on the light condensing prisms 42 to cover the light condensing prisms 42.

When in application of the light guide body 100, the bottom and top protection layer 10, 50 can be peeled off from the colloid layers.

Conclusion from the above, the first, second and third colloid layers 20, 30, and 40 are formed and solidified subsequently to be an integral structure which has the light scattering and light condensing functions.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A method for making a light guide body, the method comprising:
forming an unsolidified light-transmissible first colloid layer;
forming a top portion of the first colloid layer into a plurality of light-scattering microstructures;
solidifying the first colloid layer;
forming an unsolidified light-transmissible second colloid layer over the microstructures;
solidifying the second colloid layer;
forming an unsolidified light-transmissible third colloid layer over the second colloid layer;
forming a plurality of light condensing prisms in the third colloid layer from an opposite side of the third colloid layer to the second colloid layer; and
solidifying the third colloid layer.

2. The method of claim 1, further comprising providing a bottom protection film, the first colloid layer is formed on the bottom protection film.

3. The method of claim 2, further covering the light condensing prisms of the third colloid layer using a top protection film.

4. The method of claim 3, wherein the bottom protection film is removable from the first colloid layer, and the top protection film is removable from the third colloid layer.

5. The method of claim 1, wherein the microstructures comprise a plurality of protrusions.

6. The method of claim 1, wherein the microstructures are formed using a mold imprint method.

7. The method of claim 1, wherein microstructures are made using a particle precipitation method.

8. The method of claim 1, wherein the first and second colloid layers are made of a material selected from the group consisting of epoxy, polymethylmethacrylate, and silicone.

9. The method of claim 1, wherein the third colloid layer is made of a UV curing adhesive.

10. The method of claim 1, wherein the light condensing prisms are arranged in an array.

11. A light guide body comprising
a first solidified colloid layer having a plurality of light-scattering microstructures at an upper portion thereof,
a second solidified colloid layer being formed on and coming into contact with the upper portion of the first colloid layer, the second colloid layer covering the microstructures; and
a third solidified colloid layer formed on the second colloid layer, the third colloid layer having a plurality of light condensing prisms at an opposite side thereof to the second colloid layer.

12. The method of claim 11, wherein the microstructures comprise a plurality of protrusions.

13. The method of claim 11, wherein the light condensing prisms are arranged in an array.

14. The method of claim 11, wherein a cross section of each of the light condensing prisms is in a triangular shape.

15. The method of claim 14, wherein bottom edges of the light condensing prisms are in contact with the second colloid layer.

16. The method of claim 15, wherein the light condensing prisms covers an entire surface of the second colloid layer.
